(19) United States
(12) Patent Application Publication
(10) Pub. No.: US 2013/0102693 A1
(43) Pub. Date: Apr. 25, 2013

(54) MODIFIED FISCHER-TROPSCH CATALYST AND METHOD FOR CONVERSION OF SYNGAS

(71) Applicants: Charles Leonard Kibby, Benicia, CA (US); Gabriella Furtenbach, Watsons Bay (AU)

(72) Inventors: Charles Leonard Kibby, Benicia, CA (US); David Lawrence Trimm, Watsons Bay (AU)

(73) Assignee: CHEVRON U.S. INC., San Ramon, CA (US)

(21) Appl. No.: 13/808,094

(22) PCT Filed: Jul. 1, 2011
(86) PCT No.: PCT/AU11/00816

§ 371 Date: Jan. 2, 2013

Related U.S. Application Data
(60) Provisional application No. 61/360,967, filed on Jul. 2, 2010.

(51) Int. Cl. B01J 23/89

(52) U.S. Cl. CPC B01J 23/894
USPC 518/715; 502/300; 502/326

(57) ABSTRACT

A method of preparing a catalyst for conversion of syngas to Fischer-Tropsch hydrocarbon products comprising providing a reduced oxide Fischer-Tropsch catalyst and treating the reduced oxide catalyst with acetylene.

### FIELD

The present invention relates generally to methods of preparing catalysts for converting carbon containing products, such as natural gas, to liquid hydrocarbons or fuels, and more particularly, to methods for preparing catalysts for converting synthesis gas or “syngas” (carbon monoxide (CO) and hydrogen (H₂)) into hydrocarbon products utilizing Fischer-Tropsch (F-T) reactions and to Fischer-Tropsch reactions utilizing such catalysts.

### BACKGROUND

It is often desirable to convert solid or gaseous carbon-containing products into hydrocarbon liquids using Fischer-Tropsch (F-T) reactions. For example, the carbon based product might be coal, biomass or natural gas. These starting products are converted in a syngas generator to a synthesis gas, hereinafter referred to as “syngas”, which contains carbon monoxide (CO) and hydrogen (H₂) gases. The syngas is then converted in a Fischer-Tropsch reactor, typically in the presence of a Fischer-Tropsch catalyst which is frequently an iron or cobalt based catalyst and under suitable temperature and pressure conditions, into hydrocarbon products and other byproducts. These hydrocarbon products are usually widely distributed in carbon chains of length (C₁-C₁₀₀₊). At temperatures of approximately 22° C. and at atmospheric pressure, these produced hydrocarbon products include significant quantities of gas (C₁-C₄), liquid (C₅-C₂₀) and waxy (C₂₀₊) products. These designations of chain length for gas, liquid and waxy (solids) products are, of course, also dependent upon the relative branching of the hydrocarbon chains of the products and other known factors.

Conventional F-T synthesis of hydrocarbon products has several shortcomings. First, the synthesis is not particularly selective and can generate wide range of hydrocarbon products having carbon chain lengths of C₁ to C₁₀₀₊. Light hydrocarbons of very short chain lengths often need recycling and further processing in the F-T reactor to produce more desirable medium chain length hydrocarbons. Alternatively, these light gases can be burned as fuel to produce heat. Hydrocarbons having chain lengths in the upper end of this chain range, in general from C₂₁ to C₁₀₀₊, are considered to be waxy rather than liquid at the above described temperature of 22° C. and pressure of 1 atmosphere. Often hydrocracking is required to break these long chain length hydrocarbons down into shorter, less viscous and more desirable liquid hydrocarbon products. However, in some locations, such as on offshore oil and gas producing platforms, it is undesirable to locate hydrocracking facilities due to weight, space and economic limitations. Thus using conventional F-T conversion processes on an offshore platform is less than desirable. Also, in remote land locations, it may be undesirable to include a hydrocracking unit as the addition of this unit raises the capital and operating expenses associated with F-T production of hydrocarbon products.

### SUMMARY

There is provided a method of preparing a Fischer-Tropsch catalyst comprising providing a reduced oxide catalyst and treating the reduced oxide catalyst with acetylene.

The catalyst is preferably treated with acetylene in a gas mixture comprising the acetylene and an inert gas such as nitrogen.

The reduced oxide catalyst may be prepared by subjecting an oxide catalyst to reduction with a gas mixture comprising hydrogen and an inert gas, under conditions well described in the literature.

The F-T catalyst may be used in conversion of synthesis gas by a method comprising:
A catalyst reduction step
providing synthesis gas to an F-T reactor
reacting the synthesis gas in the presence of the F-T catalyst according to any one of the previous claims to produce F-T hydrocarbon products; and
recovering the F-T hydrocarbon products.

The gas feed used in the F-T reaction need not comprise acetylene and indeed it is preferred that the F-T catalyst is used in an F-T conversion using a gas mixture comprising syngas which comprises less than 0.5% acetylene preferably less than 0.01 mol % acetylene and most preferably free of acetylene.

Throughout the description and the claims of this specification the word “comprise” and variations of the word, such as “comprising” and “comprises” is not intended to exclude other additives, components, integers or steps.

### DETAILED DESCRIPTION

We have found that acetylene pretreatment of an F-T catalyst provides a significant change in distribution of products of F-T conversion of syngas. Acetylene is used in a pretreatment and provides advantageous conversion of the syngas into Fischer-Tropsch products.

Surprisingly, a Fischer-Tropsch (F-T) conversion of syngas to hydrocarbon products can be effected, subsequent to pretreatment of the catalyst by an acetylene-containing gas mixture, selectively to enhance the production of medium chain length hydrocarbons while reducing the production of high end chain length hydrocarbons. The selected F-T catalyst ideally has a sufficient quantity of active sites to convert carbon monoxide to medium chain length hydrocarbon products. For purposes of this application, low chain length can be considered as being C₁₋₅, medium chain length as C₆₋₂₀, and long chain lengths as C₂₁₊.

Acetylene may be incorporated with a nitrogen feed supplied to an F-T reactor. Alternatively, acetylene can be added directly to an F-T reactor, however separately from the syngas feed, in a manner to ensure acetylene is delivered evenly to the catalyst. This may involve pretreatment in a fixed or fluid bed.

Ideally, the catalyst used in acetylene enhanced syngas conversion has sufficient active sites to catalyse or oligomerise synthesis gas (CO and H₂) into hydrocarbon products of sufficient chain length such that a large portion of the F-T hydrocarbon products are liquid at ambient conditions, i.e., 1 atmosphere and 22° C., while ideally not producing significant amounts of waxy products, i.e., C₂₁₊. Such a product can ideally be transported on a conventional transport ship at approximately ambient conditions while remaining in a generally liquid or flowable state. While the F-T product is primarily liquid under such conditions and may contain some hydrocarbon gases and waxes, ideally it would still be generally “pumpable” at ambient conditions.

In the presence of an appropriate F-T catalyst and under suitable reaction conditions, an advantageous distribution of hydrocarbon products can be produced relative to those hydrocarbon products produced by conventional F-T processes. Waxy F-T products are minimized with the increase in the formation of medium chain length hydrocarbons products. Such F-T products are generally flowable at ambient conditions, i.e., 1 atmosphere and moderate temperatures. i.e., 22° C. Because of the limited amount of waxy hydrocarbon products produced, hydrocracking may be limited or eliminated when using the present acetylene enhanced syngas conversion to hydrocarbon products as compared to conventional F-T processes.

While not wishing to be held to a particular theory, the following mechanisms are believed to be involved in acetylene enhanced syngas conversion to F-T hydrocarbon products. Fischer Tropsch processing involves hydrogenation and polymerisation on the active sites of the catalyst. Pretreatment with acetylene causes conversion of acetylene to carbonaceous species if carried out under appropriate conditions. It is suggested that such carbonaceous species are deposited on highly active sites responsible for polymerisation in the Fischer Tropsch processing. Thus, the deactivation of highly active polymerisation sites by carbonaceous deposits during pretreatment leads to a smaller extent of polymerisation during the subsequent F-T reaction, to smaller amounts of heavy hydrocarbons and to increased amounts of middle distillates.

Embodiments of the invention are described in part with reference to the drawings.

### BRIEF DESCRIPTION OF THE DRAWINGS

In the drawings:

FIG. 1 shows a process scheme showing a process for pretreatment of and F-T catalyst and for converting carbon containing products into F-T hydrocarbon products using the catalyst;

FIG. 2 A schematic diagram of an acetylene enhanced syngas conversion process;

FIG. 3 is a column chart showing the hydrocarbon distribution of FT runs at pressure of 20 atm and temperature of 220 degrees C. without and with 4.0% C₂H₂ pretreatment;

FIG. 4 is a column chart comparing products in the tail gas obtained from FT runs with 4.0% C₂H₂/N₂ pretreatment and without pretreatment;

FIG. 5 is a column chart comparing the hydrocarbon distribution of FT runs at pressure of 20 atm and temperature of 220 degrees C. without and with 4% C₂H₂ pretreatment with various acetylene concentrations;

FIG. 6 is a column chart comparing products in the tail gas obtained from FT runs with 3.98% C₂H₂/N₂ pretreatment and without pretreatment at different pretreatment time;

FIG. 7 is a graph comparing the hydrocarbon distribution of FT runs at pressure of 20 atm and temperature of 220 degrees C. without and with 4% C₂H₂ pretreatment at different pretreatment time; and

FIG. 8 is a column chart comparing the hydrocarbon distribution of FT runs at pressure of 20 atm and temperature of 220 degrees C. without and with 4% C₂H₂ offline-pretreatment.

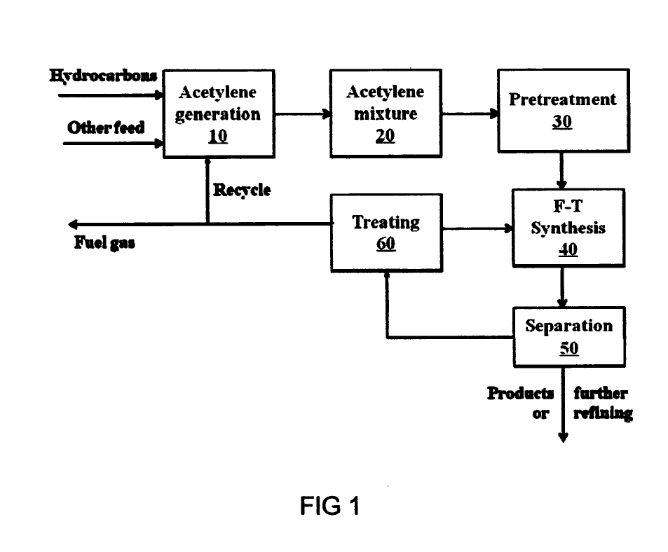

Referring to FIG. 1 there is shown a process flow diagram for converting carbon containing products into F-T hydrocarbon products. Carbon containing products may first be converted into syngas with methods which are known for converting coal and biomass into syngas. However, it is particularly desirable to convert natural gas to liquid hydrocarbons. Subsequent conversion of syngas to liquid hydrocarbons by the Fischer-Tropsch (F-T) process may then be effected.

This conversion allows hydrocarbons to be transported, such as in marine ships, in an energy efficient manner, without having to resort to liquefying or compressing the natural gas.

Acetylene can be made by the cracking of hydrocarbons or from calcium carbide. Other known techniques can be found in the Encyclopedia of Chemical Technology, Acetylene, Volume 1, 3.sup.rd Edition, Wiley, N.Y., 1978. Those skilled in the art will appreciate there are numerous other well know means of making acetylene.

Mixtures of acetylene and an inert gas such as nitrogen, argon or other mixtures, may then be supplied to the reactor containing the reduced catalyst under controlled conditions (see step 20 below). The resulting acetylene/gas feed ideally has molar ratio of greater than 0.01 of acetylene to gas, more preferably, a molar ratio in the range of 0.01 to 0.5 such as 0.011-0.10, and even more preferably a molar ratio from 0.020-0.040 or from about 0.03-0.04.

The acetylene pretreatment is generally carried out on a reduced oxide catalyst. The process involved in reduction will change with the nature of the catalyst. The treatment of the reduction of the oxide catalyst may be conducted at elevated temperature such as a temperature in the range of from 150° C. to 400° C., preferably 200° C. to 350° C.

In the case of a cobalt based catalyst, a typical procedure would involve slow heating of the catalyst to ca 300° C. under a stream of inert gas (such as nitrogen, argon or mixtures thereof) containing 10-70% hydrogen. However, it should be emphasised that the optimal reduction procedure does depend on the components of the catalyst and should be established by reference to the literature or by a second study.

In step 40 a Fischer-Tropsch conversion is performed on the acetylene-pretreated catalyst to produce an F-T product. In this particular embodiment, a conventional fixed bed Fischer-Tropsch reactor may be used for the conversion. In this example, ideally a cobalt based catalyst is used in the F-T reactor. The catalyst should contain an adequate supply of active sites to produce a significant distribution of hydrocarbon products in the range of C₅₋₂₀. The F-T hydrocarbon products produced generally have an enhanced distribution of medium chain length hydrocarbons and a reduced distribution of short-chain (gaseous) and long chain (waxy) hydrocarbons as compared to products produced by conventional F-T processes.

The F-T product produced in the F-T reactor is then separated in step 50 into a liquid F-T product and a gaseous F-T product. This is accomplished using a liquid trap which captures liquids while allowing tail gases to escape. Ideally, the captured liquid F-T product is sufficiently limited in long-chain or waxy product that the F-T liquid is flowable or pumpable at ambient temperatures, i.e. 22° C. or slightly warmer. For example, the F-T liquid product preferably has a cloud point of below 10° C. The F-T liquid product may then be placed in storage such as on a marine vessel for transport to a land based facility or else sent on for further processing and refining in a refinery.

The escaping tail gas F-T product or byproduct includes unreacted CO and H₂, methane, ethane, ethylene, CO₂, and traces of water vapor and C₃-C₅ hydrocarbons. Valuable products, such as C₃-C₅, may be separated from the rest of the tail gas and stored. The residual gaseous F-T product, including C₁-C₂ may then be reintroduced into the F-T reactor, or into the acetylene syngas generator, or else used as a fuel gas to generate heat.

### (a) Relative Amounts of Acetylene for Catalyst Pretreatment:

In one embodiment of acetylene-enhanced syngas conversion, the molar ratio of acetylene introduced into the F-T reactor relative to that of the inert gas feed is greater than 1 and less than 10%. In another embodiment, the range of acetylene used in the feed shall be 2-5% by molar ratio. In yet another embodiment, the amount of acetylene may range from 3-4% by molar ratio relative to the gas feed.

### (b) Catalyst Type

A cobalt-based catalyst is an ideal catalyst to use in the F-T reactor. The cobalt catalyst should have a sufficient number of active sites to promote the growth of hydrocarbon products of significant medium chain length, i.e., C₅-C₂₀, without producing an oversupply of longer chain length products, i.e. C₂₁₊. The cobalt-based catalyst should contain cobalt and ideally have at least 100 .mu.mol of surface metal sites per cm³ of catalyst as measured by hydrogen chemisorption. In another example, the catalyst should ideally have at least 150 .mu.mol of surface metal sites per cm³ of catalyst. In yet another example, at least 200 .mu.mol/cm³ may be used.

For example, in an experimental test setup to be described below, the catalyst used was a pretreated 20 wt % Co-0.5 wt % Ru-1.0 wt % La₂O₃ on 78.5 wt % alumina catalyst which was mixed with inert .alpha.-alumina particles, which happens to have a similar size to the catalyst.

Alternatively, iron-based catalysts may also be used. The catalysts are selected so that under suitable reaction conditions of temperature and pressure, the acetylene-pretreated, enhanced syngas conversion is converted produces primarily into liquid F-T products in the range C₃-C₂₀ while reducing the amount of short chain C₁₋₂ or “lights” and long chain (C₂₀₊) or “heavy” F-T products.

### (c) F-T Reactor Types

A variety of different types of F-T reactors may benefit from utilizing acetylene-enhanced syngas conversion. In a first embodiment, such as with the experimental set-up, the F-T reactor is a fixed or packed bed reactor. Alternatively, fluidized and spouted bed reactors may also be used. The use of a slurry bed F-T reactor is not as desirable since this type of reactor relies upon the use of waxy hydrocarbon products as the slurry medium. These products are severely limited in F-T syngas conversion using an acetylene-pretreated catalyst. Thus, a constant replenishment of the slurry medium would be required.

### (d) Reactor Pressure:

Pressure can affect the pretreatment by acetylene and the carbon number distribution of the F-T product produced in the F-T reactor. The pressure during pretreatment needs not necessarily be the same as the pressure during subsequent F-T processing. For conventional F-T processing, and by way of example and not limitation, exemplary ranges of pressures at which a fixed bed reactor may be operated include 2-35 atmospheres, 20-30 atmospheres 25-30 atmospheres and 10-20 atmospheres.

Pretreatment, on the other hand, could be carried out at different pressures, covering the same pressures as those preferred for F-T. However, pretreatment at 10 atmospheres pressure is the preferred value.

In one embodiment, the acetylene pressure in the pretreatment of the F-T catalyst will stay at approximately 0.1-0.5, preferably 0.4, atmospheres in an overall pressure of 10 atmospheres with the overall pressure in the subsequent F-T reactor being held at 2-35 atmospheres.

### (e) Reactor Operating Temperature:

Treatment of the reduced oxide catalyst with acetylene is typically conducted at a temperature in the range of from 150° C. to 250° C., preferably 150 to 220° C. Temperature is also believed to affect the chain length distribution of the F-T product produced in the F-T reactor.

Ideally, the temperature will be held between 175-230° C. for a fixed bed reactor using a cobalt-based catalyst. More preferably, the range of operating temperature would be between 190-210° C. If an iron(Fe)-based catalyst is used, then the preferred temperature would be higher with a range of 240-270° C., and more preferably, between 250-260° C.

Pretreatment temperatures need not necessarily be the same as those used for F-T processing. Pretreatment can be carried out under the same conditions as above, but the preferred temperature is at about 190° C. Some difficulty may be experienced in maintaining this temperature during pretreatment.

### (f) H₂/CO Syngas Ratio:

The preferred range of H₂/CO to be fed to an F-T reactor subsequent to pretreatment is between 2.0:1 and 2.2:1 by volume. One H₂ per CO is used to convert the O to H₂O, another H₂ per CO is used to convert the C to —CH₂— groups in the interiors of hydrocarbon chains. Any additional H₂ per CO is needed to saturate the end carbons of the hydrocarbons to CH₃(methyl) groups. If these are not saturated and olefins are formed, then the usage ratio is H₂/CO=2. The H₂/CO ratio of the synthesis gas fed to the inlet of the reactor is preferably less than the usage ratio, however, in order to minimize methane formation. This is accomplished by operating at partial conversion with recycle of the dry gas after liquid (water and C₅₊ hydrocarbons) products are removed by condensation. Consuming H₂ and CO at the usage ratio in the reactor will cause the recycle H₂/CO ratio to be lower than the inlet ratio, but that can be made up by blending the recycle flow with fresh feed that has the H₂/CO usage ratio. Varying the relative ratio of H₂ /CO can be used to alter the chain length distribution produced in the F-T reactor, but lower ratios lead to reduced synthesis rates. Preferable inlet ratios are between 1.4 and 1.7, more preferably between 1.5 and 1.6, with per pass CO conversion near 50%.

### (g) Alternative Components in Syngas Feed:

In addition to the syngas in the feed, other components may be included, such as alpha-olefins. These components can initiate hydrocarbon chains on the catalysts leading to enhanced C₅₊ paraffin and isoparaffin production.

The invention may be used with a gas feed that includes acetylene but in one set of embodiments the F-T catalyst is used in an F-T conversion using a gas added mixture comprising syngas which comprises less than 0.5% acetylene preferably less than 0.01 mol % acetylene and most preferably free of acetylene.

### (h) Residence Time in the F-T Reactor:

Residence time also affects the distribution of the F-T product produced in the F-T reactor. Residence time is the void volume in the catalyst bed divided by the volumetric flow rate corrected to the pressure and temperature at reaction conditions. It decreases as temperature goes up and increases as pressure increases. Sufficient residence time should be allowed to insure a high rate of conversion of the syngas to F-T hydrocarbon products. Ideally, the residence time is held between 1 seconds and 20 seconds, more preferably between 2 seconds and 10 seconds, and most preferably in the range of 3-5 seconds.

The residence time of the pretreatment stream depends to some extent on the concentration of acetylene in the stream. A flow rate of pretreatment gas of between 40 and 70 ml/min passing over 1 g catalysts is a typical flow, the preferred value being 60 ml/min. when the pretreatment gas contains ca 4% of C₂ H₂.

### (i) It is Not Necessary to Carry Out the Pretreatment Procedure Immediately Before the F-T Processing.

It is possible, using the procedures described below, to pretreat a reduced catalyst with an acetylene-containing gas in separate equipment. Subsequent to pretreatment, the catalyst should be rinsed with an inert gas while cooling to ambient conditions. Once the temperature has stabilised, a stream of oxygen-containing gas (usually containing 0 to 5% oxygen, but preferably ca 2% oxygen) is passed over the catalyst until the surfaces of the metals are solid is oxidised (usually overnight). The catalyst may then be removed, stored, and later transported to another position and inserted in a suitable reactor. After rinsing with inert gas the catalyst is then taken to 250-300° C. under a stream of hydrogen-containing gas. The concentration of hydrogen may vary from 10% to 70%, preferably ca 10-20%. Once reduction is complete (about 6 hours), F-T processing as described above may be initiated.

### (j) F-T Product Characteristics:

In one set of embodiments the F-T hydrocarbon product is condensed to produce a gas and an oil product at a temperature below 40° C. (at 1 atm) and the oil product comprises less than 5%, preferably less than 3% and most preferably less than 2% of hydrocarbons of at least 21 carbon atoms.

Ideally, the non-gaseous or liquid oil portion of the captured F-T product is highly liquid at ambient conditions, i.e. a temperature of 22° C. and 1 atmosphere of pressure. While the liquid will contain dissolved hydrocarbon gases and liquids, ideally the liquid would be quite flowable or pumpable. By way of example and not limitation, the liquid oil product collected from the F-T reactor ideally has the following characteristics:

Pour Point Range: −5° C. to +5° C.

Wax Content Range: 0-10%

Carbon Distribution: C₅-C₂₅

Cloud Point: below 10 degree C.

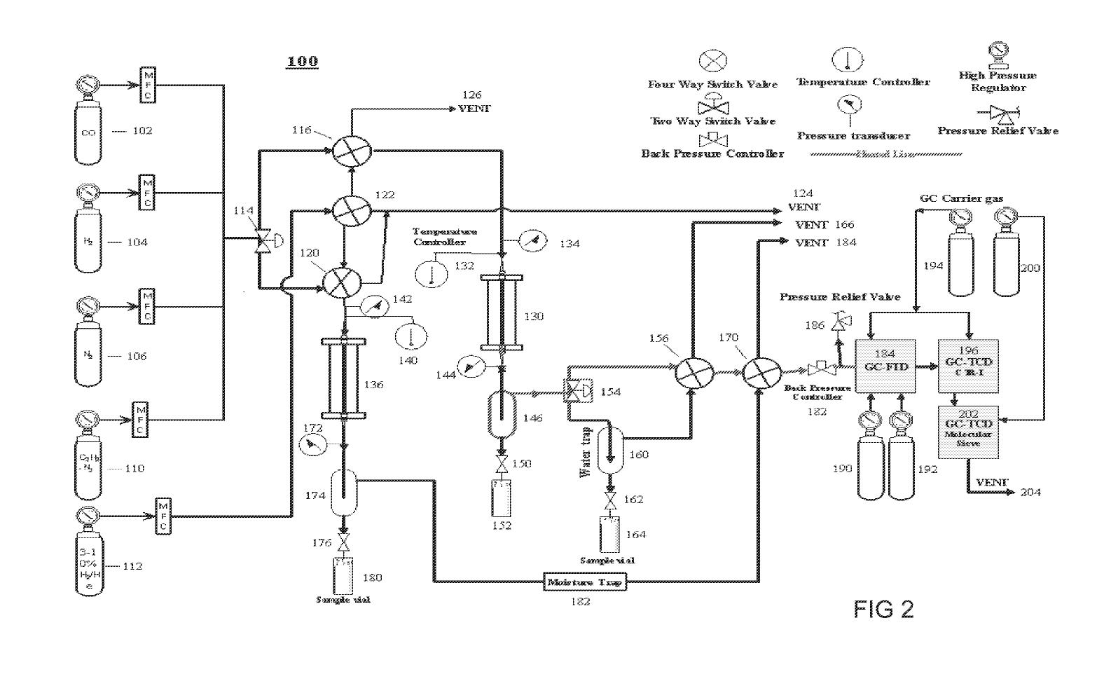

FIG. 2 shows an experimental setup 100 used to examine process variables in an acetylene enhanced syngas conversion process. Feed gases are supplied by cylinders to F-T reactors which produce F-T hydrocarbon products. These products are separated into light tail gases (C₁-C₂ hydrocarbons, CO₂, unreacted CO and H₂), heavy tail gases (C₃-C₄ hydrocarbons), liquid hydrocarbons (C₅-C₂₀), oxygenates and water, and solid hydrocarbons (C₂₁₊). Analysis equipment is used to investigate the composition of the F-T products.

With respect to supply cylinders of gas, cylinder 102 supplies carbon monoxide (CO). Cylinder 104 contains hydrogen gas (H₂). Nitrogen gas (N₂) is provided by cylinder 106 and can serve as a tracer. A mixture of acetylene (C₂H₂, ranging from 2 mol %-5 mol %) in an inert gas such as nitrogen or argon is supplied by cylinder 110. Finally, cylinder 112 ontains a 3-10% mixture of hydrogen gas (H₂) and helium (He), which serves as a reducing gas to activate F-T catalysts. All gases are fed via Brooks 5850 mass flow controllers (MFC).

A two-way switching valve 114 fluidly connects cylinders 102, 104, 106 and 110 to either of two four-way switching valves, 116 or 120. Similarly, a four-way switching valve 122 fluidly connects cylinder 112 with a vent 124. Switching valve 116 can be adjusted to deliver gas to a vent 126 or else to the first F-T reactor 130 (a fixed-bed tubular reactor, 400 mm long and 80 mm diameter. A temperature controller 132 is used to control the temperature of a furnace that encloses this reactor. A thermocouple, which can move freely in a sheath mounted to the reactor, is used to monitor the temperature along the catalyst bed in reactor 130. Pressure transducers 134 and 144 measure the pressures at the top and bottom, respectively, of reactor 130. The four-way switching valve 120 alternatively connects with a vent 124 or else delivers gas to a second F-T reactor 136. Again, a temperature controller 140 and a pressure transducer 142 are placed upstream of second F-T reactor 136.

F-T products and effluents from reactor 130 pass through lines held at approximately 150° C. to a hot trap or condenser 146. It is operated at approximately 120° C., and can capture output product from reactor 130, mainly waxes. A valve 150 can be opened to pass the waxy product to a sample vial 152. Output from reactor 130 goes to a two-way switch valve 154, that can route it directly to a four-way switching valve 156, or first through water trap 160 and then to valve 156. The water trap 160 allows liquid output, such as water and liquid hydrocarbons, by way of a valve 162, to be captured in a sample vial 164. The four-way switching valve 156 sends the vapor phase flow either to vent 166 or to another four-way switching valve 170.

F-T products and other effluents from the second F-T reactor 136 (also a fixed-bed tubular reactor, 400 mm long and 80 mm diameter) are routed past pressure transducer 172 via a heated line (at 120° C.) to product trap 174. That trap is maintained at room temperature. A valve 176 permits samples to be extracted from product trap 174 to a sample vial 180. Product trap 174 also connects to moisture trap 182 which, in turn, connects to four-way switching valve 170. A vent 184 may vent gases received from four-way switch 170. The purpose of valve 170 is to select one of the two vapor-phase product streams from the two F-T reactors for analysis in the analytical section.

Thus, four-way switching valve 170 is also connected through a back-pressure regulator 182 to a gas chromatograph-FID 184. Gas chromatograph 184 delivers light tail gas sample to gas chromatograph-TCD 196, which in turn, supplies gas chromatograph-TCD 202. Effluent from these gas chromatographs goes to vent 204. A pressure relief valve 186 allows pressure to be bled off from back-pressure controller 182. Cylinders 190 and 192, containing hydrogen gas (H₂) and compressed air, supply gas chromatograph 184. Cylinder 194 carries helium gas (He) and supplies carrier gas to gas chromatograph 184 and also to gas chromatograph-TCD 196. Argon, stored in cylinder 200, is connected to gas chromatograph 202.

Gas chromatograph-FID 184 (Shimadzu GC8A with FID detector and a Restek Rtx®-1, 60 m long, 0.53 mm internal diameter column) is utilized to analyze light hydrocarbons (C₁-C₁₂). Gas chromatograph-TCD 196 (Shimadzu GC8A with TCD detector and a CTR-I packed column) analyzes CO, CO₂, C₂H₂, N₂ and CH₄. Gas chromatograph 202 (Shimadzu GC8A chromatograph with a TCD detector and a 13× Molecular Sieve column) is used to measure the hydrogen (H₂) concentration.

Either first F-T reactor 130 or else second reactor 136 may be used in the acetylene enhanced syngas conversion of syngas to F-T products. In cases where it is suspected that waxes will be produced, first F-T reactor 130 is used in association with hot trap 146. If little or no significant amounts of waxy product (C₂₀₊) is expected to be produced, then second F-T reactor 136 may be employed in F-T product synthesis.

Liquid products are identified off line by injection into a GC-MS (Shimadzu Model QP-5050 equipped with another Rtx®-1 capillary column, also 60 m long but of 0.25 mm diameter) for qualitative analysis and a GC-FID (Shimadzu GC-17 with a FID detector fitted with a Rtx®-1 capillary column, 60 m long and 0.25 mm diameter) for quantitative analysis.

A number of experiments were conducted with experimental setup 100.

Pretreated or untreated forms of a 20 wt % Co-0.5 wt % Ru-1.0 wt % La₂O₃ on 78.5 wt % alumina catalyst were mixed with inert .alpha.-alumina particles (which have similar size to the catalyst) and packed and supported between two quartz wool plugs in the test reactor.

The first stage of pretreatment consisted of reducing the catalyst in flowing, 70% hydrogen at atmospheric pressure while heating slowly (1° C./minute) to 300° C. and holding for at least 6 hours, cooling to ambient temperature, purging in nitrogen, passivating the catalyst in nitrogen-diluted air at ambient temperature, reoxidizing it by heating slowly to 300° C. in flowing air, cooling again, purging in nitrogen, then repeating the reduction and passivation steps. This redox treatment makes the catalyst much easier to activate later in either diluted hydrogen or at lower temperatures or both. These preliminary reduction and oxidation steps were done outside the test reactor.

In the second stage of pretreatment, the catalyst was then transferred to the reactor and reduced in situ in 10% H₂/N₂ at 300° C. for ca. 20 hr (by ramping temperature to 150° C. at 10° C./min and holding for 1 hour, followed by increasing the temperature to 300° C. at 3° C./min and holding for 20 hours).

The third stage of pretreatment involved contact with acetylene. The reactor temperature was slowly decreased to room temperature in 5% H₂/N₂. Before switching an acetylene in nitrogen (or other inert gas) blend to the reactor for pretreatment, the inlet compositions of the acetylene blends were analysed for N₂ and C₂ H₂ by diverting those gas mixtures to GC 196 and GC 184, respectively. Pretreatment with acetylene was initialized by switching the inlet gas to the reactor (130 or 136) from the hydrogen in nitrogen blend to an acetylene in nitrogen blend and then ramping the temperature (at a rate of 5° C./min) and pressure to the target values. After the pretreatment had proceeded for the desired time, the catalyst was rinsed with N₂ for 15 minutes.

Subsequent to this rinsing, syngas was admitted to the reactor (130 or 136) at the desired concentrations (as described in step 40 section 2), and the temperature was slowly increased to the desired value. Analytical measurements were carried out to determine when the process approached steady state—usually after some 100 minutes operation. Reproducible analytic measurements were then taken every 1-2 hours. During the reaction, online gas analyses were conducted via GC-FID (184), GC-TCD (196) and GC-TCD (202) for C₁-C₁₂ light hydrocarbons, CO, CO₂, N₂, C₂H₂, CH₄ and H₂, respectively. The liquid product collected was analyzed quantitatively and qualitatively offline, using GC-FID and GC-MS for condensed high hydrocarbons (C₅₊) and oxygenates.

The invention will now be described with reference to the following examples. It is to be understood that the examples are provided by way of illustration of the invention and that they are in no way limiting to the scope of the invention.

### Examples

The following exemplary range of process variables might be used in the experimental setup 100. In commercial set ups, of course, a broader range of the process variables can be practiced, as described elsewhere in this specification.
Pretreatment temperature: 190° C.
Acetylene content: 0-4% (vol)
Pretreatment: total flow rate: 60 ml/min.
Pressure: 10 atmospheres
Pretreatment time: 60 minutes
Catalyst loading: 1 gram/cubic centimeter of reactor void
F-T reaction temperatures: 190-210° C.
[H₂:CO ratio: 2.0-2.3
F-T reactor pressure: 5, 10, 20 atmospheres
Total inlet gas flowrate: 60-120 mL/min
Reaction time: 18-48 hours;

### Analysis Performed Online:

| | |
|---|---|
| Tail gas (GC-TCD) | CO, CO₂, N₂, H₂, CH₄, C₂H₂ and C₁— |
| GC-FID (Rtx-1 capillary column) | C₁₂ |

### Offline Liquid Product Analysis:

| | |
|---|---|
| GC-MS (Shimadzu Model QP-5050) | Qualitative analysis |
| GC-FID (Shimadzu GC-17) | Quantitative analysis |

### Comparative Example 1

A first, generally acetylene free run was made utilizing the experimental test setup 100 above. The process variables for normal F-T reaction are shown in the below table:

TABLE 1
FT conditions

| | |
|---|---|
| Acetylene (dry volume %) | 0% |
| Catalyst | 1 gram |
| Reactor temperature | 220° C. |
| Reactor pressure | 20 atm |
| H₂/CO ratio | 2.1 |
| Reaction time | 15 hours |
| Residence time | 150.0 mmol/h/g _{catalyst} |

### Results:

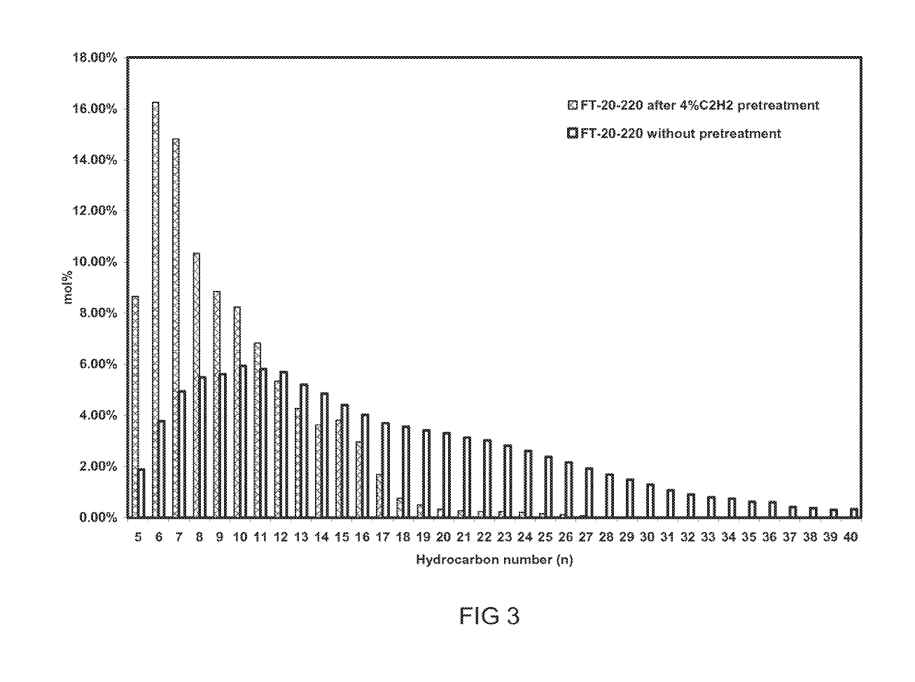

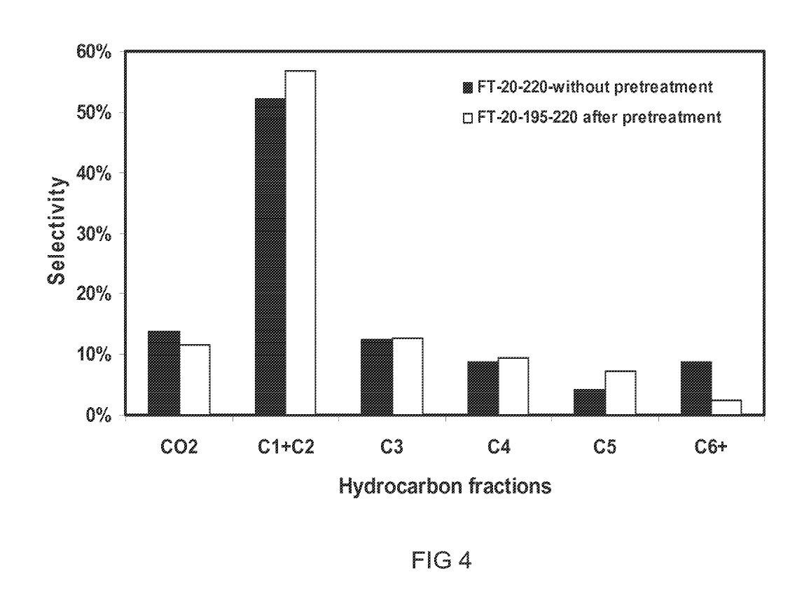

The conversions of carbon monoxide and hydrogen were about 76.2% and 76.4%, respectively, at these conditions. The carbon number distribution of the F-T product oil from the reactors is shown in FIG. 3. The selectivities to carbon dioxide and light hydrocarbons (C₁-C₆) in the tail gas is shown in FIG. 4.

### Example 2

Firstly, acetylene pretreatment was performed on a reduced Co-based catalyst at 10 atm and 190° C. with 4% acetylene/nitrogen. After flushing under nitrogen, a conventional FT run was carried out on the pretreated catalyst at 20 atm and 220° C. The process variables for this run are shown in Table 2:

TABLE 2
Acetylene pretreatment conditions

| | |
|---|---|
| Acetylene (dry volume %) | 3.98% |
| Catalyst | 1 gram |
| Pretreatment temperature | 190° C. |
| Pretreatment pressure | 10 atm |
| Pretreatment time | 7 hours |
| Residence time | 144.5 mmol/h/g _{catalyst} |

FT conditions

| | |
|---|---|
| Acetylene (dry volume %) | 0% |
| Catalyst | 1 gram |
| Reactor temperature | 220° C. |
| Reactor pressure | 20 atm |
| Reaction time | 5 hours |
| Residence time | 150.0 mmol/h/g _{catalyst} |

### Results:

The conversions of CO and H₂ were about 53% and 57%, respectively after acetylene pretreatment, which only slightly decreased compared with F-T run without acetylene pretreatment. The carbon number distribution of the F-T product oil from the reactor is shown in FIG. 3. The long tail of oil products usually observed for F-T runs became insignificant after acetylene pretreatment and the hydrocarbon distribution shifted towards much lighter hydrocarbon fractions (C₆-C₁₁). More than 90% of the liquids were C₅-C₂₀ products and less than 4% were C₂₁₊ heavy products. The resulting F-T oil after acetylene pretreatment was very clear. The results of tail gas analysis shown in FIG. 4 indicated that the formation rate of carbon dioxide also dropped after acetylene pretreatment.

### Example 3

Effect of Acetylene Concentration on F-T Product Distribution.

A study on the effect of acetylene concentration during pretreatment on the subsequent F-T product distribution was carried out at 190° C. and 10 atm for 7 hours, according to the process conditions of acetylene pretreatment and F-T reaction shown in Table 3:

TABLE 3

| | | | Reaction | | |
|---|---|---|---|---|---|
| | Temperature | Pressure | time | Acetylene, | SV, |
| Run | ° C. | atm | hr | % | mmol/h/g_{cat} |
| 1.8% C₂H₂/N₂ | 190 | 10 | 7 | 1.8 | 144.5 |
| 4.0% C₂H₂/N₂ | 190 | 10 | 7 | 4.0 | 140.2 |
| FT, after C₂H₂ | 220 | 20 | 15 | 0 | 142.8 |

### Results:

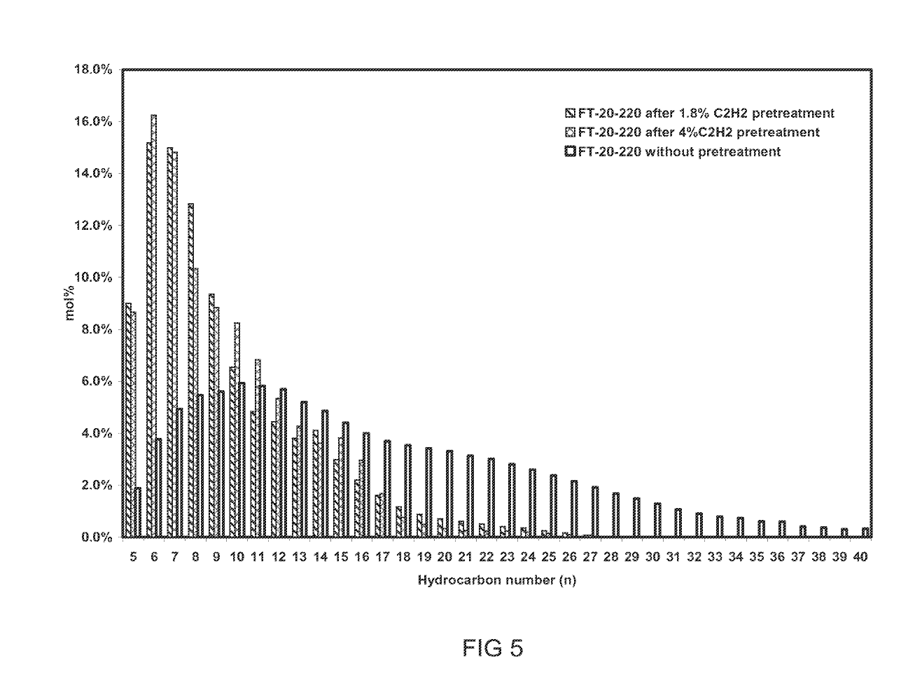

FIG. 5 shows the carbon number distribution of the oil products during the F-T reaction without pretreatment and after pretreatment with various concentrations of acetylene in the nitrogen feed. The CO conversions in these runs were 74% without pretreatment, 69% after treatment with 1.8% acetylene, and 53% after treatment with 4% acetylene. It is clearly demonstrated that the long tail of oil products for the F-T reaction is also reduced after acetylene pretreatment with the lower acetylene concentration. As shown in FIG. 5, the hydrocarbon distribution shift towards lighter products is almost the same for the two acetylene concentrations. With 1.8% acetylene pretreatment, the selectivity to the C₅-C₉ fraction increased to 47% and the selectivity to C₂₁₊ wax decreased from 13.7% to 5.8%. Further increasing acetylene concentration to 4.0%, the selectivity to C₅-C₉ fractions was about the same, at 45%, but the selectivity to C₂₁₊ wax further decreased to 3.1%. The oil liquid collected from the F-T reaction after pretreatment in 1.8% acetylene was a milky liquid, containing some insoluble wax, whereas that for F-T synthesis after treatment with 4.0% acetylene was clear, with no indication of wax.

### Example 4

Effects of Acetylene Pretreatment Time on Subsequent F-T Product Distributions.

The acetylene pretreatment was performed at 190° C. and 10 atm with 4.0% acetylene/nitrogen. The pretreatment time was varied from 3 to 12 hours. After acetylene pretreatment, F-T synthesis was performed at 220° C. and 20 atm for 15 hours. The process conditions during acetylene pretreatment are shown in Table 4.

TABLE 4

| | Temper- | | Reaction | | |
|---|---|---|---|---|---|
| | ature | Pressure | time | Acetylene | SV |
| Run | ° C. | P | hr | % | mmol/h/g_{cat} |
| C₂H₂/N₂— 5 hr | 190 | 10 | 5 | 4.0 | 140.2 |
| C₂H₂/N₂— 7 hr | 190 | 10 | 7 | 4.0 | 140.2 |
| C₂H₂/N₂— 10 hr | 190 | 10 | 10 | 4.0 | 144.5 |

### Results:

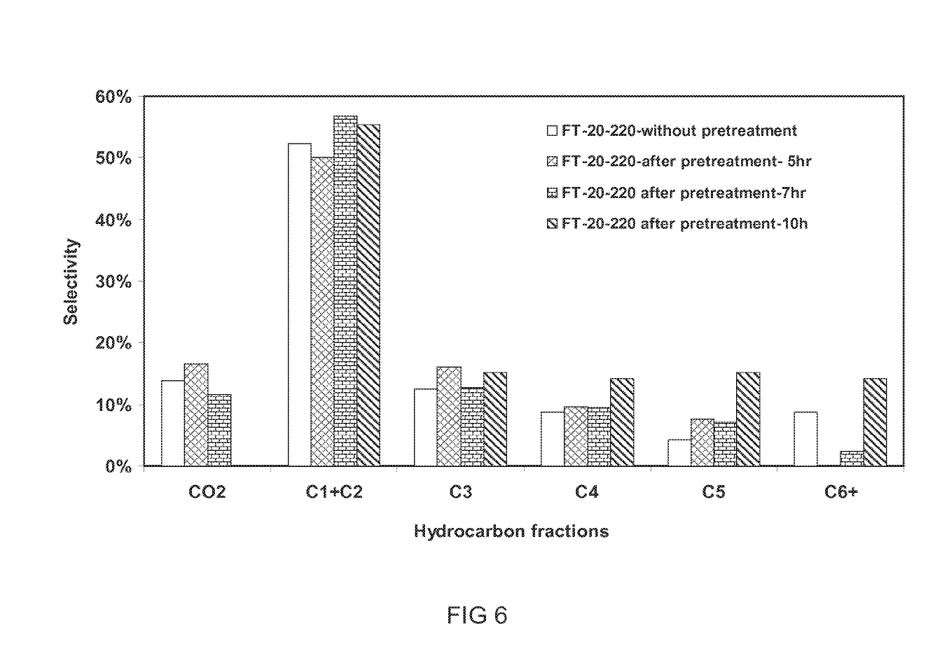

The CO conversions in subsequent F-T runs were 59%, 53% and 52%, respectively, after treatments at 5, 7, and 10 hours in 4% acetylene. Compared with the normal F-T run without pretreatment, these CO conversions are lower by 20%-30%. FIG. 6 shows selectivities of products in the tail gas during F-T reactions without and with 4% acetylene pretreatment for various times. Note that the selectivities to C₃-C₅ in the tail gas phase increased after acetylene pretreatment.

Liquid hydrocarbons collected from the cold traps showed that there were still waxes being formed after short (3-5 hour) pretreatments. By extending the pretreatment time to 7 and 10 hours, clear, wax-free liquids were collected. After the 7 hour pretreatment, the hydrocarbon liquid was pale yellow; while after pretreatment for 10 hours, the color of the oil liquid turned bright yellow.

With increasing pretreatment time, the relative amounts of C₅-C₉ fractions and C₁₀-C₂₀ fractions in the liquids from the F-T runs increased significantly. They went from <0.1% without treatment to 15.0% at 5 hours and 45% at 7 hours. The C₂₁+ fractions decreased from 14% without treatment to 9% at 5 hours and 3% at 7 hours.

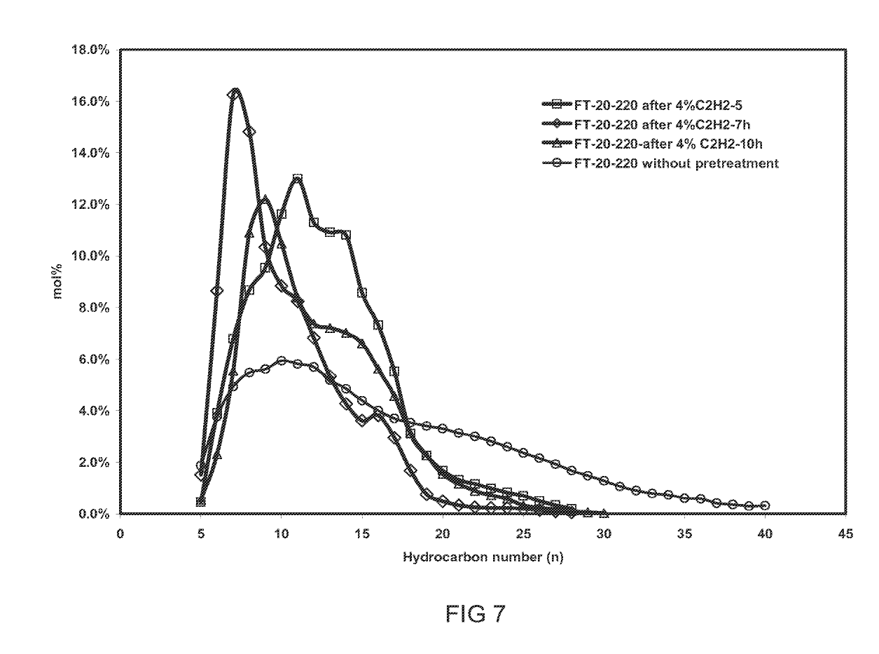

FIG. 7 presents the carbon number distributions of the oil products in F-T runs with or without acetylene pretreatment. It is apparent that the long tail (the C₂₆₊ fractions) of oil products for F-T is reduced significantly after pretreatment and the hydrocarbon distribution shifts to lighter hydrocarbon fractions (mainly C₆-C₁₇) as the pretreatment time increases from 3 hours to 10hours.

4% acetylene pretreatment at 190° C. effectively modifies carbon number distributions during subsequent syngas conversion at 220° C. and 20 atm. It shifts them from broad distributions extending out to C₃₀ hydrocarbons to naphtha and diesel/gasoline-range hydrocarbons (C₆-C₁₇). The optimum pretreatment time for the catalyst tested was 7 h with 4% C₂H₂/N₂ at 190° C. and 10 atm.

### Example 5

F-T Reaction on Offline-Acetylene-Pretreatment Catalysts

Offline acetylene pretreatment on F-T catalysts is investigated. A reduced catalyst was pretreated with an acetylene-containing gas in separate equipment and then be removed, stored, and later transported to another position and inserted in a suitable reactor. Before running the F-T reaction, the offline-acetylene-pretreated catalyst was initially reduced at 300° C. under a stream of hydrogen-containing gas. The concentration of hydrogen may vary from 10% to 70%, preferably ca 10-20%. Once reduction is complete (about 6 hours), F-T processing as described above is performed at 220° C. and 20 atm for 15 h.

### Results:

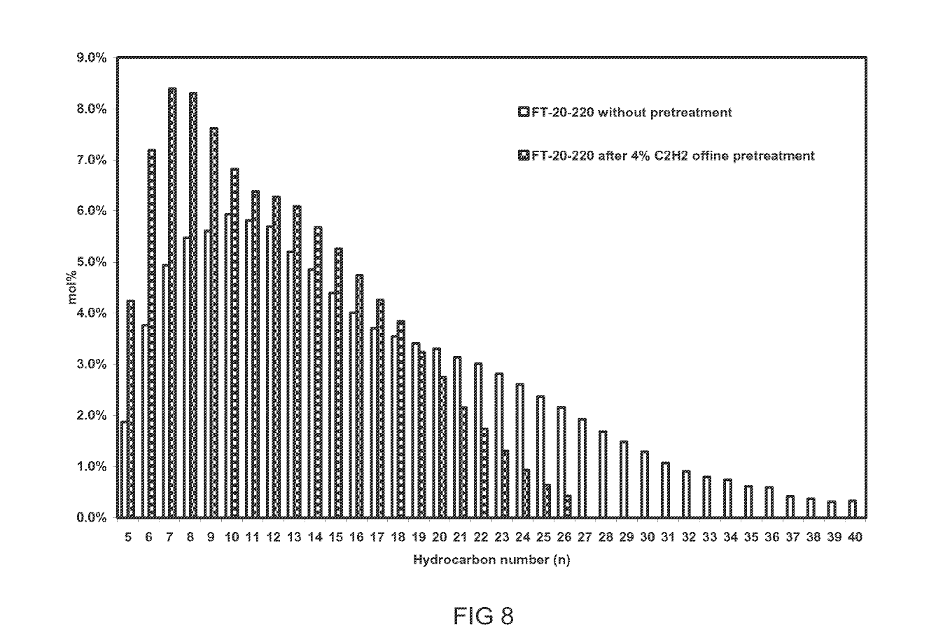

The conversions of CO and H₂ for F-T reaction on this acetylene-pretreated catalyst remain the same value compared with the unpretreated catalyst. The clear oil products were collected from the cold trap. FIG. 8 shows the carbon number distributions of the oil products in F-T runs with or without acetylene pretreatment. It is apparent that the long tail (the C₂₇₊ fractions) of oil products for F-T is reduced significantly after offline pretreatment and the hydrocarbon distribution shifts to lighter hydrocarbon fractions (mainly C₆-C₁₇) as in-suit acetylene pretreatment. Therefore, this confirmed that it is possible to pretreat F-T catalysts and store and later transport them to another place without losing the desired effect

1. A method of preparing a catalyst for conversion of syngas to Fischer-Tropsch hydrocarbon products comprising providing a reduced oxide Fischer-Tropsch catalyst and treating the reduced oxide catalyst with acetylene.

2. A method according to claim 1, wherein the catalyst is treated with acetylene in a gas mixture comprising the acetylene and an inert gas.

3. A method of preparing an F-T catalyst according to claim 1, wherein the reduced oxide catalyst is prepared by subjecting an oxide catalyst to reduction with a gas mixture comprising hydrogen and an inert gas.

4. A method according to claim 2, wherein the inert gas is nitrogen.

5. A method according to claim 1, wherein the treatment of the reduced oxide catalyst with acetylene is conducted at a temperature in the range of from 150° C. to 250° C.

6. A method according to claim 5, wherein the temperature is in the range of from 150° C. to 220° C.

7. A method according to claim 3, wherein the reduced oxide catalyst is treated with acetylene in a mixture with an inert gas wherein the molar ratio of acetylene/inert gas is in the range of greater than 0.01, preferably 0.01 to 0.05 and more preferably 0.010 to 0.040 and still more preferably from 0.03-0.04.

8. A method according to claim 7, wherein the molar ratio of acetylene/inert gas is in the range of from 0.01 to 0.05.

9. A method according to claim 7, wherein the molar ratio of acetylene/inert gas is in the range of from 0.03-0.04.

10. A method according to claim 1, wherein the catalyst comprises at least one of cobalt, rhuthenium or iron.

11. A method according to claim 10, wherein the catalyst comprises cobalt.

12. A method according to claim 1, wherein the catalyst is a cobalt based catalyst and the process of reducing the oxide catalyst comprises heating a cobalt based oxide catalyst in the presence of a gas stream comprising an inert gas and from 10-70% of the gas stream of hydrogen.

13. A method according to claim 7, wherein the oxide catalyst is heated to a temperature of from 150 to 400° C.

14. A method according to claim 1, wherein the F-T catalyst is used in an F-T conversion using a gas added mixture comprising syngas which comprises less than 0.5 mol % acetylene.

15. A method according to claim 14, wherein the gas mixture comprising syngas comprises less than 0.01 mol % acetylene.

16. A method according to claim 14, wherein the gas mixture comprising syngas is free of acetylene.

17. A method according to claim 1 further comprising:
providing synthesis gas to an F-T reactor
reacting the synthesis gas in the presence of the F-T catalyst to produce F-T hydrocarbon products; and
recovering the F-T hydrocarbon products.

18. A method according to claim 17, wherein the syngas is free of acetylene.

19. A method according to claim 17, wherein the F-T hydrocarbon product is condensed to produce a gas and an oil product at a temperature below 40° C. (at 1 atm) and the oil product comprises less than 5% of hydrocarbons of at least 21 carbon atoms.

20. A method according to claim 19, wherein the oil product comprises less than 3% of hydrocarbons of at least 21 carbon atoms.
